(19) United States
(12) Patent Application Publication
(10) Pub. No.: US 2006/0058970 A1
(43) Pub. Date: Mar. 16, 2006

(54) Analytical method for reducing quantitative analysis systematic error of real-time fluorescence thermal cycler and the applications of the same

(76) Inventors: Pingjian Deng, Shenzhen (CN); Dongyan Yang, Shenzhen (CN)

Correspondence Address: ARTHUR KING MA, 1030 CORONADO DRIVE, ARCADIA, CA, 91007, US

(21) Appl. No.: 11/025,748

(22) Filed: Dec. 28, 2004

(30) Foreign Application Priority Data
Sep. 16, 2004 (CN) 200410051557.4

(51) Int. Cl. G06F 19/00

(52) U.S. Cl. 702/20

(57) ABSTRACT

The invention provides an analytical method to reduce the quantitative analysis systematic error of real-time fluorescence thermal cycler for polymerase chain reaction (PCR) and the application thereof. In the method, tₙ, the amplifying time by which fluorescence intensity (Rₙ) gets to a certain threshold, is set as the measuring index and initial template copy number (X₀) is calculated according to the linear quantitative relation between tₙ and X₀, shown as the formula 1: lnX₀=−ln(1+E)(tₙ/t_{c})+lnK. Particularly, the method firstly needs to measure the values of tₙ of the standard samples whose X₀ are known and protract the standard curve about lnX₀˜tₙ; then to measure the values of tₙ of samples and calculate the initial copy number of samples in terms of the standard curve. In the process of measuring tₙ, real-time fluorescence thermal cycler collects fluorescent signals in the pattern of continuous scanning and measures real-time fluorescence intensity. The instrument is set to measure fluorescence intensity (Rₙ) in PCR tube in the frequency of any interval ranging from 0.01 second to 10 second in extending period. The dynamic curve about Rₙ˜t is automatically shown on the screen. On the dynamic curve, the amplifying time by which the intensity of fluorescent signals gets to the threshold is defined as tₙ. The method reduces the serious systematic error that the previous analytical pattern has and can be widely used in such fields as gene expression, gene engineering, drug curative effect, pathogen detection and genetically modified component detection, etc.

### BACKGROUND OF THE PRESENT INVENTION

1. Field of Invention

The invention relates to an analytical method and its applications and in particular to such an analytical method and its applications to reduce the quantitative analysis systematic error of real-time fluorescence thermal cycler.

2. Description of Related Arts

In prior art, for the existing polymerase chain reaction (PCR), there is linear relation between the logarithm of initial template copy number (lnX₀) and the cycle (n) at which the templates are accumulated to a certain value. This is the principle of quantitative PCR (Higuchi et al. 1993) and real-time fluorescence quantitative PCR (FQ-PCR) is founded on the base. In reaction system of FQ-PCR a fluorescent probe is added, and a fluorescent molecule is produced corresponding to increasing a pair of templates. The cycle, at which fluorescence intensity is accumulated to a certain threshold, is defined as Cₜ. In the process of the whole amplification, fluorescence intensity is detected only once in each cycle and Cₜ is measured according to fluorescence intensity. There is linear quantitative relation between lnX₀ and Cₜ.
lnX₀=−ln(1+E)Cₜ+lnK (2)

This is the principle of fluorescence quantitative PCR (Christian et al. 1996) (In formula (2), E means amplification efficiency; K is a constant). Described the principle in detail, it firstly needs to measure the values of Cₜ of standard samples and then protract the standard curve about lnX₀˜Cₜ; then to measure the values of Cₜ of samples and calculate the initial copy number of samples in terms of the standard curve. In comparison to the routine PCR, real-time fluorescence quantitative PCR has been the DNA quantitative technology with the widest application foreground since it has such advantages as higher specificity, higher sensitivity, lower PCR contamination and higher automatization level.

The main limitation of the previous real-time fluorescence quantitative PCR is that the quantitative analysis result has serious error. The accepted systematic error of it reaches to 80%˜100%, so it can't satisfy the request of quantitative analysis veracity.

### SUMMARY OF THE PRESENT INVENTION

A main object of the invention is to provide an analytical method to reduce the quantitative analysis systematic error of real-time fluorescence thermal cycler and application thereof. The analytical method can obviously increase the veracity and precision of the quantitative analysis results and obviously decrease the detection limit of the quantitative analytical method.

### DETAILED DESCRIPTION OF THE PREFERRED EMBODIMENT

The systematic error of real-time fluorescence quantitative PCR is mainly derived from the measurement procedure of the existing real-time fluorescence thermal cycler. The measurement procedure of the existing apparatus is established on the relation shown as formula (2). The measuring index is Cₜ and the measuring pattern is that fluorescence intensity is detected only once in each cycle. The criterion used to judge Cₜ is whether fluorescence intensity (Rₙ) is accumulated to a certain threshold. In other words, the least difference of Cₜ that the instrument can exactly distinguish is a cycle.

For example, there are two samples and their template initial copy numbers are X₀₁ and X₀₂. After respectively measuring the values of Cₜ, Cₜ₁, and Cₜ₂ are obtained and the difference between X₀₁ and X₀₂ can be calculated according to formula (2) when Cₜ₁ and Cₜ₂ have the difference of a cycle.
lnX₀₁=−ln(1+E)Cₜ₁+lnK (3)
lnX₀₂=−ln(1+E)Cₜ₂+lnK (4)

Formula (3)—formula (4), then
ln(X₀₁/X₀₂)=−ln(1+E)(Cₜ₁−Cₜ₂)=−ln(1+E) (5)

If the value of E is assumed as 1, its maximal value, formula (5) is
ln(X₀₁/X₀₂)=−0.6931, then X₀₁/X₀₂=0.5000, X₀₁=0.5000 X₀₂X₀₂−X₀₁=X₀₂=0.5000 X₀₂=(1−0.5000)X₀₂=0.5000 X₀₂

The result suggests that the values of Cₜ have the difference of a cycle only when the initial template copy numbers of two samples have the difference of one times. That is to say, the instrument can distinguish the difference only when the difference between X₀₁ and X₀₂ is not less than 0.5000 times of X₀₂. If the difference between the initial template copy numbers of samples doesn't reach to one times, the measured values of Cₜ can't accurately indicate it, so the systematic error of the quantitative result almost gets to 100%.

The principle of the invention in which tₙ is set as the measuring index in real-time fluorescence quantitative PCR:

(1) Real-time fluorescence PCR dynamic equation about amplifying time and fluorescence intensity

For PCR, there is such exponential relation as formula (6) between the accumulative total of the amplified templates and cycle number.
Xₙ=X₀(1+E)ⁿ (6)

In the formula:
Xₙ is the accumulative total of the amplified templates in reaction tube.
X₀ is the initial template copy number in reaction tube.
E is PCR amplification efficiency.
n is the cycle number of PCR amplification.

For TaqMan FQ-PCR, a fluorescence molecule is formed when a double-stranded DNA is amplified in theory. On the assumption that the produced fluorescence intensity is Rₙ, the formation efficiency of fluorescence molecule is P. P is defines as the values of fluorescent signals produced when a double-stranded DNA is amplified. That is

$${R}_{n} = \frac{1}{2} {PX}_{n} \qquad ( 7 )$$

To take formula (6) into formula (7), then

$${R}_{n} = \frac{1}{2} {PX}_{n} = \frac{1}{2} {{PX}_{0} ( 1 + E )}^{n} \qquad ( 8 )$$

Formula (8) suggests that there is exponential relation between fluorescence intensity (Rₙ) and cycle number (n) for FQ-PCR.

In the period of template amplification, because of the influence of competitive binding of templates and primers, reaction velocity of DNA polymerase and other factors, the fluorescence molecules in reaction tube are not formed in the same time, but gradually accumulated along with time, so the fluorescence intensity in reaction tube gradually increases along with time.

It is assumed that amplifying time is t, the durative time of each PCR cycle is t_{c}, then there is such relation between cycle number (n) and amplifying time (t) as:
t=n×t_{c} (9)
or
n=t/t_{c}

To take formula (9) into formula (8), then

$${R}_{n} = \frac{1}{2} {PX}_{n} = \frac{1}{2} {{PX}_{0} ( 1 + E )}^{t / {t}_{c}} \qquad ( 10 )$$

Formula (10) suggests that there is exponential relation between fluorescence intensity (Rₙ) and (t/t_{c}) for FQ-PCR. Because t_{c} can be set as a constant, there is exponential relation between the fluorescence intensity (Rₙ) and amplifying time (t).

(2) Relations among amplifying time (t), fluorescence intensity (Rₙ) and initial template copy number (X₀)

Formula (10) is treated by logarithm, then
lnX₀=lnRₙ−ln(P/2)−ln(1+E)(t/t_{c}) (11)

It is assumed that the amplifying time by which fluorescence intensity (Rₙ) is accumulated to a certain threshold (Rₜ) is defined as tₙ, Rₜ and P are constants, and lnRₜ−ln(P/2)=lnK, then formula (11) becomes
lnX₀=−ln(1+E)(tₙ/t_{c})+lnK (1)

Because t_{c} can be set as a constant, formula (1) shows that there is linear quantitative relation between lnX₀ and tₙ, which offers the base to quantitatively detect X₀ by measuring the value of tₙ. According to the quantitative relation shown as formula (1) to measure the values of tₙ of standard samples whose X₀ are known, and to protract the standard curve about lnX₀˜tₙ; then to measure the values of tₙ of samples and calculate the initial copy numbers of samples in terms of the standard curve.

While measuring the value of tₙ, real-time fluorescence thermal cycler collects fluorescent signals in the pattern of continuous scanning and measures real-time fluorescence intensity. Considering that the formation efficiency of fluorescence molecules in denaturing and annealing phases is much lower than it in extending period, the fluorescent signals produced in the two phases can be ignored. In such case, the instrument is set to measure fluorescence intensity (Rₙ) in PCR tube in the frequency of any interval ranging from 0.01 second to 10 second in extending period. Therefore, in practical calculation, tₙ is applied as the total of all extending periods before the time point that fluorescent signal intensity gets to the threshold, and t_{c} is applied as the extending durative time in each cycle. If instrument measures fluorescence intensity (Rₙ) in the frequency of 0.01 second, the precision that instrument can distinguish the least difference of tₙ is 0.01 second.

The mathematical treatment mode of fluorescent signals: As the fluorescent signals obtained by continuous scanning accord with the dynamic equation of PCR amplification, the dynamic curve about Rₙ˜t is more accurate and the signals are easy to have such mathematical treatments as integral treatment and differential treatment. The values can be augmented after integral treatment and are easy to be distinguished and detected; the instrument can reduce the noise pollution and be easy to distinguish signals from noise pollutions after differential treatment.

The better technical scheme of the invention is instrument measures fluorescence intensity (Rₙ) in the frequency of 0.01 second. Since the precision that instrument can distinguish the least difference of tₙ is 0.01 second, the instrument (tₙ acts as measuring index) can divide one cycle into 6000 smaller units (60 sec/0.01 sec) if the extending period in a cycle is 1 minute. As a result, the measuring accuracy of instrument is greatly increased.

The analytical method in the present invention can be used in such fields as: To detect the relation between initial copy number of the internal Lectin gene of soya bean and Cₜ, tₙ; To detect the relation between initial copy number of the foreign 35S gene of plant samples and Cₜ, tₙ; To detect the relation between initial copy number of hepatitis B virus (HBV) in the blood samples and Cₜ, tₙ; To detect the relation between initial copy number of the foreign NOS gene in plant samples and Cₜ, tₙ; To detect the relation between initial copy number of the internal Zein gene in maize and Cₜ, tₙ. The content of soya bean in samples can be quantitatively measured by measuring the copy number of Lectin; the content of maize in samples can be quantitatively measured by measuring the copy number of Zein; the content of genetically modified component in samples can be quantitatively measured by measuring the copy number of 35S or NOS; the content of HBV in samples can be quantitatively measured by measuring the copy number of HBV DNA. A point needs to explain: Because 35S gene extracted from different plant species can be quantitatively measured in the same real-time fluorescence PCR conditions, the measuring conditions of soya bean 35S gene can represent the measuring conditions of 35S gene extracted from other plant species. Similarly, because NOS gene extracted from different plant species can be quantitatively measured in the same real-time fluorescence PCR conditions, the measuring conditions of maize NOS gene can represent the measuring conditions of NOS gene extracted from other plant species.

In comparison to the existing technology, the obvious advantages of the invention include: 1. increasing the instrument's precision in wide range. The least unit of Cₜ that instrument can distinguish is one cycle, while the least unit of tₙ that instrument can distinguish is 0.01 second. The instrument (tₙ acts as measuring index) can divide one cycle into 6000 smaller units (60 sec/0.01 sec) if the extending period in a cycle is 1 minute. As a result, the measuring accuracy of instrument is greatly increased. 2. increasing the veracity of quantitative result in wide range. After tₙ acts as measuring index, the instrument can distinguish the least difference of tₙ is 0.01 second. For example, there are two samples and their initial template copy numbers are X₀₁ and X₀₂. After respectively measuring tₙ, tₙ₁ and tₙ₂ are obtained and the difference between X₀₁ and X₀₂ can be calculated according to formula (5) when tₙ₁ and tₙ₂ have the difference of 0.01 second.

$$\begin{matrix}ln ( {X}_{01} / {X}_{02} ) = - ln ( 1 + E ) ( {C}_{t1} - {C}_{t2} ) \\ = - ln ( 1 + E ) ( {t}_{n1} / {t}_{c} - {t}_{n2} / {t}_{c} ) \\ = - 0.6931 \times ( 0.01 / 60 ) \\ = - 1.155 \times {10}^{- 4} \\ {X}_{01} / {X}_{02} = 0.9999 or \\ {X}_{01} = 0.9999 {X}_{02}\end{matrix}$$

The difference of the initial template copy number of two samples that the instrument can accurately indicate is:
X₀₂−X₀₁=X₀₂−0.9999 X₀₂=(1−0.9999)X₀₂=0.0001 X₀₂

The result suggests that instrument can distinguish the difference when the difference between X₀₁ and X₀₂ is not less than 0.0001 times of X₀₂. The veracity of the new method increases about 5000 times compared with the existing method. 3. decreasing the detection limit of quantitative method in wide range. The detection limit of real-time fluorescence quantitative PCR is decided by Signal-to-Noise. If Signal-to-Noise is higher, the detection limit is lower. Signals are increased and noise pollutions are decreased after mathematical treatments, so the instrument detection limit is lowered and the instrument detection ability is enhanced. 4. wider application fields. The method can be widely used in such fields as gene expression, gene engineering, drug curative effect, pathogen detection and genetically modified component detection, etc.

### EXAMPLES

The following will describe the invention at large by enumerating some examples.

### Example 1

### Detection of the Relation Between the Initial Template Copy Number of the Internal Lectin Gene of Soya Bean and Cₜ, tₙ

A. Principle

Lectin is the internal gene of soya bean and there is quantitative relation between its template copy number and the content of soya bean in samples. The content of soya bean in samples can be quantitatively measured by measuring the copy number of Lectin. A pair of primers used to amplify Lectin gene and a fluorescent hybridization probe that can specially bind to Lectin template are added into fluorescence PCR system. The two ends of the probe are respectively labeled by a reporter fluorophore and a quencher fluorophore. While the probe is intact, the quencher fluorophore absorbs the fluorescence from the reporter fluorophore. During the extension phase of PCR cycle, the probe attached to the template is degraded by the inherent exonuclease activity of the DNA polymerase, which separates the quencher fluorophore from the reporter fluorophore, and allows the reporter to give off fluorescent signals. The formation of each fluorescent molecular is corresponding to the amplification of each double-stranded Lectin gene. When fluorescence intensity added up to a certain threshold decided by the instrument, the corresponding cycle number is Cₜ and the corresponding period of amplifying time is tₙ. In a certain condition, there is linear relation between the initial copy number of Lectin in PCR tube and Cₜ or tₙ.

To extract DNA from standard samples and add certain amounts of the extracted DNA solution, the primers used to amplifying Lectin gene and the corresponding probe into PCR tube, then the amplification reaction of real-time fluorescence thermal cycler starts in a certain reaction system and amplification condition. Instrument respectively detects fluorescent signals in the two conditions that Cₜ or tₙ acts as measuring index. The dynamic curve of Rₙ (fluorescence intensity)˜C (cycle number) or Rₙ˜t (amplifying time) is shown on the instrument screen. Using the dynamic curve to decide the values of Cₜ or tₙ and then to protract the standard curves about lnX₀˜Cₜ and lnX₀˜tₙ, in turn, to get standard curve equations.

After DNA is extracted from soya bean samples, certain amounts of the extracted DNA solution is added into PCR tube, then to prepare the solutions containing different amounts of Lectin. The values of Cₜ or tₙ are measured following the measuring condition in which standard samples are measured. To analyze and compare the relations between the initial copy number of Lectin gene and Cₜ or tₙ.

B. The Details of Carrying Out

1. Materials

1-1 Regents

DNA extraction kit: Qiagen Dneasy Plant Mini Kit or other commercially available kits; primers and probe (shown in table 1).

TABLE 1

The primer and probe sequences
specific for Lectin gene

| | |
|---|---|
| The detected gene | Lectin |

| | |
|---|---|
| Primer sequences | Forward: |
| | 5′-cctcctcgggaaagttacaa-3′ |
| | Reverse: |
| | 5′-gggcatagaaggtgaagtt-3′ |
| Probe sequence | 5′-ccctcgtctcttggtcgcgccctct-3′ |

1-2 Apparatus and Reaction System:

Real-Time Fluorescence Thermal Cycler: Bio-Rad iCycler

PCR reaction system: 10×Buffer 2.5 μL, MgCl₂ (25 mmol/L) 2.0 μL, dNTP (10 mmol/L) 0.5 μL, Primer-I:(30 μmol/L) 0.4 μL, Primer-II (30 μmol/L) 0.4 μL, Probe (30 μmol/L) 0.2 μL, Taq enzyme (5 U/μL) 0.3 μL, UNG enzyme (1 U/μL) 0.1 μL, Template 5 μL, add H₂O to 25 μL.

Instrument measuring conditions: 50° C. 3 min; 95° C. 10 min; 95° C. 15 sec, 60° C. 1 min (To measure Cₜ, detecting fluorescent signals once in a cycle; To measure tₙ, detecting the fluorescent signals once a second), 40 cycles.

Running of real-time fluorescence thermal cycler: To put PCR tubes in sample trough in a certain order (To press the lids of the PCR tubes tightly before running, otherwise fluorescent materials will contaminate instrument), then instrument starts to run, to manipulate the instrument according to its instruction manual, at last, to calculate and print the results.

1-3 Samples: Roundup Ready Soya Bean Standard Samples (The Content of Soya Bean is 100%) from Fluka Co.

2. Method:

2-1 Sample Preparation: 50 g Soya Bean is Comminuted to the Size of 0.5 mm by Muller or Other Comminuting Apparatus.

2-2 Extraction of DNA and Preparation

To put 100.0 mg the comminuted samples into a centrifugal tube that has the capacity of 1.5 mL or 2.0 mL, then to extract DNA according to the method supplied by Kits, to adjust the volume of the extracted DNA solution to 100 μL finally.

2-3 Protraction of Standard Curve

The extracted DNA solution of standard sample is diluted in grades, as a result, a series of diluted standard solution with different concentrations are obtained. To respectively measure the values of Cₜ or tₙ of each solution and protract the standard curves about lnX₀˜Cₜ and lnX₀˜tnₙ, in turn, to get standard curve equations.

2-4 Measuring of Samples

The extracted DNA solutions of samples whose volumes are 0.4, 0.6, 0.8, 1.0, 1.2, 1.4, 1.6, 1.8, 2.0, 2.2 μL are involved in PCR amplification and measure the values of Cₜ or tₙ of each solution.

3 Results and Analysis

3-1 Standard Curve Equations

(1) The standard curve equation about lnX₀˜Cₜ for Lectin gene:
lnX₀=−0.7001Cₜ+11.665

(2) The standard curve equation about lnX₀˜tₙ for Lectin gene:
lnX₀=−0.7001(tₙ/60.00)+11.665
3-2 The Measuring Results of Samples

The measuring results of the values of Cₜ or tₙ of each sample solution are shown in table 2.

TABLE 2
The measuring results of each sample solution:

| | Number | | | | | | | | | |
|---|---|---|---|---|---|---|---|---|---|---|
| | 1 | 2 | 3 | 4 | 5 | 6 | 7 | 8 | 9 | 10 |
| DNA Solution(μL) | 0.4 | 0.6 | 0.8 | 1.0 | 1.2 | 1.4 | 1.6 | 1.8 | 2.0 | 2.2 |
| Cₜ (cycle) | 24 | 23 | 23 | 23 | 22 | 22 | 22 | 22 | 22 | 21 |
| tₙ (second) | 1458 | 1424 | 1399 | 1380 | 1364 | 1351 | 1339 | 1330 | 1320 | 1312 |

3-3 Analysis of the Results and Comparing:

Table 2 suggests that the 2nd˜4th (X₀₂/X₀₄=0.600) samples have the same values and the 5th˜9th (X₀₅/X₀₉=0.600) samples have the same values when Cₜ is measured. It is to say, the values of Cₜ can't distinguish the difference of the initial Lectin copy numbers of these samples. The different measuring results can be obtained in different sample solutions when tₙ is measured and the values of tₙ can accurately indicate the initial copy number of Lectin. So the quantitative analysis results are more accurate by measuring the values of tₙ.

### Example 2

### Detection of the Relation Between the Initial Copy Number of the Foreign 35S Gene of Plant Samples and Cₜ, tₙ

A. Principle

35S is the foreign promotor that most genetically modified plants contained and there is quantitative relation between its template copy number and the content of genetically modified plant in samples. The content of genetically modified plant in samples can be quantitatively measured by measuring the template copies of 35S. A pair of primers used to amplifying 35S and a TaqMan probe that can bind on 35S template are added into the fluorescence PCR system. The measuring principle and steps of 35S are same with them of Lectin gene.

B. The Details of Carrying Out

1. Materials

1-1 Regents

DNA extraction kit: Qiagen Dneasy Plant Mini Kit or other commercially available kits; primers and probe (shown in table 3).

TABLE 3

The primer and probe sequences
specific for 35S gene

| | |
|---|---|
| The detected gene | 35S |

| | |
|---|---|
| Primer sequences | Forward: |
| | 5′-cgacagtggtccaaaga-3′ |
| | Reverse: |
| | 5′-aagacgtggttggaacgtcttc-3′ |
| Probe sequence | 5′-tggacccccacccacgaggagcatc-3′ |

1-2 Apparatus and Reaction System: Same with the Apparatus and Reaction System of Example 1.

Instrument measuring conditions: 50° C. 3 min; 95° C. 10 min; 95° C. 15 sec, 60° C. 1 min (To measure Cₜ, detecting fluorescent signals once in a cycle; To measure tₙ, detecting the fluorescent signals once a 0.1 second), 40 cycles.

1-3 Samples: Roundup Ready Genetically Modified (GM) Soya Bean Standard Samples (The Content of GM Soya Bean is 5%) from Fluka Co.

2. Method:

2-1 Sample Preparation: Same with the Preparation Method of Example 1.

2-2 Extraction of DNA and Preparation: Same with the DNA Extraction Method of Example 1.

2-3 Protraction of Standard Curve

The extracted DNA solution of standard sample (GM %=5%) is diluted in grades, as a result, a series of diluted standard solution with different concentrations are obtained. To respectively measure the values of Cₜ or tₙ of each solution and protract the standard curves about lnX₀˜Cₜ and lnX₀˜tₙ, in turn, to get standard curve equations.

2-4 Measuring of the Sample

The extracted DNA solutions of samples whose volumes are 0.5, 1.0, 1.5, 2.0, 2.5, 3.5, 4.0, 4.5, 5.0 μL are involved in PCR amplification and measure the values of Cₜ or tₙ of each solution.

3 Results and Analysis

3-1 Standard Curve Equations

(1) The standard curve equation about lnX₀˜Cₜ for 35S gene:
lnX₀=−0.6988Cₜ+12.051

(2) The standard curve equation about lnX₀˜tₙ for 35S gene:
lnX₀=−0.6988(tₙ/60.00)+12.051
3-2 The Measuring Result of Samples

The measuring results of the values of Cₜ or tₙ of each sample solution are shown in table 4.

TABLE 4
The measuring results of each sample solution:

| | Number | | | | | | | | | |
|---|---|---|---|---|---|---|---|---|---|---|
| | 1 | 2 | 3 | 4 | 5 | 6 | 7 | 8 | 9 | 10 |
| DNA Solution(μL) | 0.5 | 1.0 | 1.5 | 2.0 | 2.5 | 3.0 | 3.5 | 4.0 | 4.5 | 5.0 |
| Cₜ (cycle) | 26 | 25 | 25 | 25 | 24 | 24 | 24 | 24 | 23 | 23 |
| tₙ (second) | 1618.8 | 1559.4 | 1524.6 | 1500.0 | 1480.8 | 1465.2 | 1452.0 | 1440.0 | 1430.4 | 1421.4 |

3-3 Analysis of the Results and Comparing:

Table 4 suggests that the 2nd˜4th (X₀₂/X₀₄=0.500) samples have the same values, the 5th˜8th (X₀₅/X₀₈=0.625) samples have the same values and the 9th˜10th (X₀₉/X₁₀=0.900) samples have the same values when Cₜ is measured. It is to say, the values of Cₜ can't distinguish the difference of initial copy number of these samples. The different measuring results can be obtained in different sample solutions when tₙ is measured and the values of tₙ can accurately indicate the initial copy number of 35S. So the detection of the initial 35S copy number is more accurate by measuring the values of tₙ.

### Example 3

### Detection of the Relation Between the Initial Copy Number of Hepatitis B Virus (HBV) in the Blood Samples and Cₜ, tₙ

A. Principle

There is quantitative relation between the copy number of HBV DNA segments and the content of HBV in samples. The content of HBV in samples can be quantitatively measured by measuring the copy number of HBV DNA segments. The HBV PCR fluorescence quantitative detection kit is used, and detection is according to the instruction manual.

B. The Details of Carrying Out

1. Materials

1-1 Regents: HBV PCR Fluorescence Quantitative Detection Kit (Supplied by Shenzhen Piji Bio-Engineering Co. of China).

1-2 Apparatus and Reaction System

Real-Time Fluorescence Thermal Cycler: Bio-Rad iCycler

Instrument measuring conditions: 37° C. 5 min; 94° C. 1 min; 95° C. 5 sec, 60° C. 30 sec (To measure Cₜ, detecting fluorescent signals once in a cycle; To measure tₙ, detecting fluorescent signals once a 0.01 second), 42 cycles.

1-3 Samples

No. 1˜4 Standard samples: (1˜5)×10⁴˜(1˜5)×10⁷ copies/mL (Supplied together with the kit); Control samples: negative control sample, strong positive control and critical positive control sample (Supplied together with the kit).

2. Method

2-1 DNA Extraction of Sample and Preparation

To extract DNA of 100 μL strong positive control sample according to the instruction manual of detection kit and to adjust the volume of the extracted DNA solution to 100 μL finally.

2-2 Protraction of Standard Curve

To add the No. 1˜4 Standard samples into PCR tubes and respectively measure the values of Cₜ or tₙ of each solution, then protract the standard curves about lnX₀˜Cₜ and lnX₀˜tₙ, in turn, to get standard curve equations.

2-3 Measuring of Samples

The extracted DNA solutions of samples whose volumes are 1.2, 1.4, 1.6, 1.8, 2.0, 2.2, 2.4, 2.6, 2.8, 3.0 μL into PCR tubes and measure the values of Cₜ or tₙ of each solution.

3 Results and Analysis

3-1 Standard Curve Equations

(1) The standard curve equation about lnX₀˜Cₜ for HBV:
lnX₀=−0.3396Cₜ+14.918

(2) The standard curve equation about lnX₀˜tₙ for HBV:
lnX₀=−0.3396(tₙ/60.00)+14.918
3-2 The Measuring Results of Samples

The measuring results of the values of Cₜ or tₙ of each sample solution are shown in table 5.

TABLE 5
The measuring results of each sample solution:

| | Number | | | | | | | | | |
|---|---|---|---|---|---|---|---|---|---|---|
| | 1 | 2 | 3 | 4 | 5 | 6 | 7 | 8 | 9 | 10 |
| DNA Solution(μL) | 1.2 | 1.4 | 1.6 | 1.8 | 2.0 | 2.2 | 2.4 | 2.6 | 2.8 | 3.0 |
| Amount of HBV | 264.4 | 308.5 | 352.6 | 396.6 | 440.7 | 484.8 | 528.8 | 572.9 | 617.0 | 661.0 |
| (copies/mL) | | | | | | | | | | |
| Cₜ (cycle) | 27 | 27 | 26 | 26 | 26 | 25 | 25 | 25 | 25 | 24 |
| tₙ (second) | 825.03 | 810.06 | 799.62 | 789.34 | 780.07 | 771.60 | 763.85 | 756.61 | 750.04 | 744.08 |

3-3 Analysis of the Results and Comparing:

Table 5 suggests that the 1st˜2nd (X₀₁/X₀₂=0.857) samples have the same values, the 3th˜5th (X₀₃/X₀₅=0.8006) samples have the same values and the 6th˜9th (X₀₆/X₀₉=0.788) samples have the same values when Cₜ is measured. It is to say, the values of Cₜ can't distinguish the difference of initial HBV copy numbers of these samples. The different measuring results can be obtained in different sample solutions when tₙ is measured and the values of tₙ can accurately indicate the initial copy number of HBV. So the detection of the initial HBV copy number is more accurate by measuring the value of tₙ.

### Example 4

### Detection of the Relation Between the Initial Copy Number of the Foreign NOS Gene of Plant Sample and Cₜ, tₙ

A. Principle

NOS is the foreign terminator that most genetically modified plants contained and there is quantitative relation between its template copy number and the content of genetically modified plant in samples. The content of genetically modified plant in samples can be quantitatively measured by measuring the template copy number of NOS. A pair of primers used to amplifying NOS and a TaqMan probe that can bind on NOS template are added into fluorescence PCR system. The measuring principle and steps of NOS are same with them of Lectin gene.

B. The Details of Carrying Out

1. Materials

1-1 Regents

DNA extraction kit: Qiagen Dneasy Plant Mini Kit or other commercially available kits; primers and probe (shown in table 6).

TABLE 6

The primer and probe sequences
specific for NOS gene

| | |
|---|---|
| The detected gene | NOS |

| | |
|---|---|
| Primer sequences | Forward: |
| | 5′-atcgttcaaacatttggca-3′ |
| | Reverse: |
| | 5′-attgcgggactctaatcata-3′ |
| Probe sequence | 5′-catcgcaagaccggcaacagg-3′ |

1-2 Apparatus and Reaction System: Same with the Apparatus and Reaction System of Example 1.

Instrument measuring conditions: 50° C. 3 min; 95° C. 10 min; 95° C. 15 sec, 60° C. 1 min (To measure Cₜ, detecting fluorescent signals once in a cycle; To measure tₙ, detecting fluorescent signals once a 0.1 second), 40 cycles.

1-3 Samples: Bt11 GM Maize Standard Sample (The Content of GM Maize is 2%) from Fluka Co.

2. Method:

2-1 Sample Preparation: Same with the Preparation Method of Example 1.

2-2 Extraction of DNA and Preparation: Same with the DNA Extraction Method of Example 1.

2-3 Protraction of the Standard Curve

The extracted DNA solution of standard sample (GM %=2%) is diluted in grades, as a result, a series of diluted standard solution with different concentrations are obtained. To respectively measure the values of Cₜ or tₙ of each solution and protract the standard curves about lnX₀˜Cₜ and lnX₀˜tₙ, in turn, to get standard curve equations.

2-4 Measuring of Samples

To respectively put the extracted DNA solutions of samples whose volumes are 0.5, 1.0, 1.5, 2.0, 2.5, 3.5, 4.0, 4.5, 5.0 μL into PCR tubes and measure the values of Cₜ or tₙ of each solution.

3 Results and Analysis

3-1 Standard Curve Equations

(1) The standard curve equation about lnX₀˜Cₜ for NOS gene:
lnX₀=−0.7667Cₜ+14.9752

(2) The standard curve equation about lnX₀˜tₙ for NOS gene:
lnX₀=−0.7667(tₙ/60.00)+14.9752

3-2 The Measuring Results of Samples

The measuring results of the values of Cₜ or tₙ of each sample solution are shown in table 7.

TABLE 7
The measuring results of each sample solution:

| | Number | | | | | | | | | |
|---|---|---|---|---|---|---|---|---|---|---|
| | 1 | 2 | 3 | 4 | 5 | 6 | 7 | 8 | 9 | 10 |
| DNA Solution(μL) | 0.5 | 1.0 | 1.5 | 2.0 | 2.5 | 3.0 | 3.5 | 4.0 | 4.5 | 5.0 |
| Cₜ (cycle) | 25 | 24 | 23 | 23 | 23 | 22 | 22 | 22 | 22 | 22 |
| tₙ (second) | 1506.0 | 1451.7 | 1419.9 | 1397.4 | 1380.0 | 1365.6 | 1353.6 | 1342.8 | 1333.8 | 1326.0 |

3-3 Analysis of the Results and Comparing:

Table 7 suggests that the 3th˜5th (X₀₃/X₀₅=0.600) samples have the same values and the 6th˜10th (X₀₆/X₁₀=0.600) samples have the same values when Cₜ is measured. It is to say, the values of Cₜ can't distinguish the difference of initial NOS copy number of these samples. The different measuring results can be obtained in different sample solutions when tₙ is measured and the values of tₙ can accurately indicate the initial copy number of NOS. So the quantitative analysis result is more accurate by measuring the value of tₙ.

### Example 5

### Detection of the Relation Between the Initial Copy Number of the Internal Zein Gene of Maize and Cₜ, tₙ

A. Principle

Zein is the internal gene of maize and there is quantitative relation between its template copy number and the content of maize in samples. The content of genetically modified plant in samples can be quantitatively measured by measuring the template copy number of Zein. A pair of primers used to amplifying Zein and a TaqMan probe that can bind on Zein template are added into fluorescence PCR system. The measuring principle and steps of Zein are same with them of Lectin gene.

B. The Detail of Carrying Out

1. Materials

1-1 Regents

DNA extraction kit: Qiagen Dneasy Plant Mini Kit or other commercially available kits; primers and probe (shown in table 8).

TABLE 8

The primer and probe sequences
specific for Zein gene

| | |
|---|---|
| The detected gene | Zein |

| | |
|---|---|
| Primer sequences | Forward:5′-tgaaccatgcatgcagt-3′ |
| | Reverse:5′-ggcaagaccattggtga-3′ |
| Probe sequence | 5′-tggcgtgtccgtccctgatgc-3′ |

1-2 Apparatus and Reaction System: Same with the Apparatus and Reaction System of Example 1.

Instrument measuring conditions: 50° C. 3 min; 95° C. 10 min; 95° C. 15 sec, 60° C. 1 min (To measure Cₜ, detecting fluorescent signals once in a cycle; To measure tₙ, detecting fluorescent signals once a 10.00 second), 40 cycles.

1-3 Samples: Maize Standard Sample (The Content of Maize is 100%) from Fluka Co.

2. Method:

2-1 Sample Preparation: Same with the Preparation Method of Example 1.

2-2 Extraction of DNA and Preparation: Same with the DNA Extraction Method of Example 1.

2-3 Protraction of Standard Curve:

The extracted DNA solution of standard sample (maize %=100%) is diluted in grades, as a result, a series of diluted standard solution with different concentrations are obtained. To respectively measure the values of Cₜ or tₙ of each solution and protract the standard curves about lnX₀˜C, and lnX₀˜tₙ, in turn, to get standard curve equations.

2-4 Measuring of Samples

To respectively put the extracted DNA solutions of samples whose volumes are 0.4, 0.6, 0.8, 1.0, 1.2, 1.4, 1.6, 1.8, 2.0, 2.2 μL into PCR tubes and measure the values of Cₜ or tₙ of each solution.

3 Results and Analysis

3-1 Standard Curve Equations

(1) The standard curve equation about lnX₀˜Cₜ for Zein gene:
lnX₀=−0.5685Cₜ+12.973

(2) The standard curve equation about lnX₀—tₙ for Zein gene:
lnX₀=−0.5685(tₙ/60.00)+12.973
3-2 The Measuring Results of Samples

The measuring results of the values of Cₜ or tₙ of each sample solution are shown in table 9.

TABLE 9
The measuring results of each sample solution:

| | Number | | | | | | | | | |
|---|---|---|---|---|---|---|---|---|---|---|
| | 1 | 2 | 3 | 4 | 5 | 6 | 7 | 8 | 9 | 10 |
| DNA Solution(μL) | 0.4 | 0.6 | 0.8 | 1.0 | 1.2 | 1.4 | 1.6 | 1.8 | 2.0 | 2.2 |
| Cₜ (cycle) | 22 | 22 | 21 | 21 | 21 | 20 | 20 | 20 | 20 | 19 |
| tₙ (second) | 1370 | 1330 | 1300 | 1270 | 1260 | 1240 | 1220 | 1210 | 1200 | 1190 |

3-3 Analysis of the Results and Comparing:

Table 9 suggests that the 1st˜2nd (X₀₁/X₀₂=0.666) samples have the same values, the 3th˜5th (X₀₃/X₀₅=0.666) samples have the same values and the 6th˜9th (X₀₆/X₀₉=0.666) samples have the same values when Cₜ is measured. It is to say, the values of Cₜ can't distinguish the difference of initial Zein copy number of these samples. The different measuring results can be obtained in different sample solutions when tₙ is measured and the values of tₙ can accurately indicate the initial copy number of Zein. So the detection of the initial Zein copy number is more accurate by measuring the value of tₙ.

What is claimed is:

1. An analytical method to reduce the quantitative analysis systematic error of real-time fluorescence thermal cycler. The analysis process needs to synthesize a pair of primers and a fluorescent probe, and the primers, the probe and other components form fluorescence PCR system. The DNA extracted from samples and the cDNA gained from RNA, extracted from samples, by reverse transcription are added in reaction system and mixed, then polymerase chain reaction begins and measure fluorescent signals. The characteristics is shown as:
(a) In the real-time fluorescence quantitative analysis, the amplifying time (tₙ) by which fluorescence intensity (Rₙ) gets to a certain threshold is set as measuring index, and initial template copy number (X₀) is calculated according to the linear quantitative relation between tₙ and X₀, shown as the following formula:
lnX₀=−ln(1+E)(tₙ/t_{c})+lnK (1)
In formula (1), E means amplification efficiency; K is a constant; X₀ is the initial copy number of template; t_{c} is the durative time of each PCR cycle.
Particularly, the method firstly needs to measure the values of tₙ of the standard samples whose X₀ are known and protract the standard curve about lnX₀˜tₙ; then to measure the values of tₙ of samples and calculate the initial copy numbers of samples in terms of the standard curve.
(b) In the process of measuring tₙ, real-time fluorescence thermal cycler collects fluorescent signals in the pattern of continuous scanning and measures the real-time fluorescence intensity. The instrument is set to measure fluorescence intensity (Rₙ) in PCR tube in the frequency of any interval ranging from 0.01 second to 10 second in extending period. The dynamic curve about Rₙ˜t is automatically shown on the screen. When the time point that the intensity of fluorescent signals adds up to a certain threshold appears in the curve, the corresponding period of amplifying time is tₙ.

2. The analytical method as claimed in claim 1 wherein said fluorescence intensity Rₙ in PCR tube is detected at an interval of 0.01 second.

3. The analytical method as claimed in claim 1 wherein the method is used to detect the relation between the initial copy number of the internal Lectin gene of soya bean and Cₜ, tₙ.

4. The analytical method as claimed in claim 1 wherein the method is used to detect the relation between the initial copy number of the foreign 35S gene of plant samples and Cₜ, tₙ.

5. The analytical method as claimed in claim 1 wherein the method is used to detect the relation between the initial copy number of hepatitis B virus (HBV) in blood samples and Cₜ, tₙ.

6. The analytical method as claimed in claim 1 wherein the method is used to detect the relation between the initial copy number of the foreign NOS gene of plant samples and Cₜ, tₙ.

7. The analytical method as claimed in claim 1 wherein the method is used to detect the relation between the initial copy number of the internal Zein gene of maize and Cₜ, tₙ.
